(19) United States
(12) Patent Application Publication
(10) Pub. No.: US 2024/0249276 A1
(43) Pub. Date: Jul. 25, 2024

(54) SYSTEM AND METHOD FOR STORING ACCESS TO DIGITAL ASSETS AND OTHER SENSITIVE DATA ON THE BLOCKCHAIN AND ISSUING NFT FOR LOGIN ACCESS IN A DIGITAL SAFE, THEREBY ALLOWING RECOVERY OR TRANSFER OF OWNERSHIP THEREOF UNDER DEFINED CIRCUMSTANCES

(71) Applicants: Liew Teak Han, Milton Keynes (GB); Shruti Chandrasekar, Chennai (IN)

(72) Inventors: Liew Teak Han, Milton Keynes (GB); Shruti Chandrasekar, Chennai (IN)

(21) Appl. No.: 18/101,065

(22) Filed: Jan. 24, 2023

(51) Int. Cl. G06Q 20/36

(52) U.S. Cl. CPC G06Q 20/3678

(57) ABSTRACT

A computer implemented method including obtaining a viewing key of a smart contract, encrypting the viewing key and creating a non-fungible token of the viewing key. The computer implemented method further including splitting the non-fungible token into a first portion, a second portion, and a third portion. The non-fungible token of the viewing key is configured to be deployable on different or same blockchain networks.

### BACKGROUND OF THE INVENTION

### 1. Field of the Invention

The present inventive concept relates to the field of terminal technologies, and in particular, to digital asset transfer methods and apparatus, and an electronic device.

### 2. Description of Related Art

There have been previous devices that have been developed that relate to digital asset storage systems and methods. The growth of the digital asset class has introduced the world to an asset like no other. Simultaneously intangible and immutable, for so many it now forms the basis of providing financial well-being and security for both them and their loved ones. People regularly store their digital assets in various forms ranging from paper to software and hardware options, and accounts on centralized exchanges. However, each of these traditional approaches suffer from significant disadvantages and security vulnerabilities.

Generally speaking, these devices are decentralized data storage systems with single point of failure security, and include only external mechanisms for data ownership transfer, which are expensive, time-consuming and complicated.

Paper wallets have been one attempted solution. As simple as it sounds, a user of the paper wallet method writes down a seed and/or secret phrase to recover their digital assets in the event of a software and/or hardware wallet failure. If not properly secured, backed up and safeguarded, these wallets can be discarded mistakenly as trash.

Software wallets have been another attempted solution. Free and easy to use, developers of these wallets offer 12- or 24-word secret phrases designed for wallet recovery and/or remote access. Still, many users store this valuable seed phrase in emails and on Internet of Things (IOT) devices, significantly increasing potential exposure to hacks that could result in a substantial financial loss.

Hardware wallets have been yet another attempted solution. If the owner loses or damages a hardware wallet, their assets may be locked and inaccessible permanently, unless the seeds are saved in a secure place.

Centralized exchange accounts have been still another attempted solution. Such accounts are notoriously weak in regard to asset security due to the ease with which many exchanges are regularly hacked, or voluntarily cease operation. This can result in catastrophic losses of assets, both digital and fiat alike, for their users. A few notable examples include the following: MtGox [see https://jimmysong.medium.com/mt-gox-hack-technical-explanation-37ea5549f715] (2014), Bitstamp [see https://www.coindesk.com/markets/2015/07/01/details-of-5-million-bitstamp-hack-revealed] (2015), Bitfinex [see https://www.coindesk.com/markets/2016/08/03/the-bitfinex-bitcoin-hack-what-we-know-and-dont-know] (2016), Coincheck [see https://www.bbc.com/news/world-asia-42845505] (2018), Binance [see https://www.cnbc.com/2019/05/08/binance-bitcoin-hack-over-40-million-of-cryptocurrency-stolen.html] (2019), KuCoin [see https://cointelegraph.com/news/kucoin-ceo-says-insurance-covered-16-of-losses-from-285m-hack-in-2020] (2020), AscendEx [see https://www.coindesk.com/business/2021/12/13/crypto-exchange-ascendex-hacked-losses-estimated-at-77m] (2021). Centralized exchange accounts leave users without direct ownership of their funds. This is the basis for the modern aphorism, “not your keys, not your crypto.” This lack of direct control contradicts one of the key tenets of decentralized finance, effectively forcing users to trust fully a centralized storage vendor with the custodianship of their valuable digital assets.

Therefore, what is desired is a system and method that provides greater data security and enables more convenient and easier automated ownership transfer of digital assets.

### SUMMARY OF THE INVENTION

The present inventive concept provides automated ownership transfer of digital assets.

Certain of the foregoing and related aspects and/or features are readily attained according to the present general inventive concept by providing a computer implemented method that includes obtaining a viewing key of a smart contract; encrypting the viewing key; and creating a non-fungible token of the viewing key.

The method may include splitting the non-fungible token into a first portion, a second portion, and a third portion.

The non-fungible token of the viewing key may be configured to be deployable on different or same blockchain networks.

The method may include deploying the first portion to a first blockchain network, deploying the second portion to a second blockchain network, and deploying the third portion to a third blockchain network, wherein the first, second, and third blockchain networks comprise different or same blockchain networks.

The method may further include prior to obtaining the viewing key of the smart contract, receiving user data, encrypting the user data, and storing the user data in the smart contract.

The method may further include subsequent to storing the user data in the smart contract, deploying the smart contract on a secret network.

The non-fungible token may be split into the first, second, and thirds portions using Shamir's Secret Sharing.

The access to the data in the smart contract may require ownership of at least two of the three non-fungible token portions.

The access to the data in the smart contract may further require identification by at least one biometric security device.

The method may further include enabling a user to make payments for fees associated with creation and deployment of the smart contract and the non-fungible token from any smart wallet.

Certain of the foregoing and related aspects and/or features are readily attained according to the present general inventive concept by providing a computer implemented method including encrypting user data; creating a smart contract, wherein the smart contract includes the encrypted user data, is deployed on a secret network, includes a viewing key, wherein the viewing key controls access to the data of the smart contract, and is configured to mint non-fungible tokens; obtaining the viewing key of the smart contract, encrypting the viewing key, minting via the smart contract a non-fungible token of the encrypted viewing key, splitting the non-fungible token into a first portion, a second portion, and a third portion, wherein each portion includes at least a part of the viewing key.

The non-fungible token may be configured to be deployable on different blockchain networks.

The method may further include deploying each of the first portion, second portion, and third portion of the non-fungible token to a different blockchain network.

The access to the data in the smart contract may require ownership of at least two portions of the non-fungible token.

The method may further include transferring ownership information of the first portion of the non-fungible token to a smart wallet associated with a user, storing ownership information of the second portion of the non-fungible, and transferring ownership information of the third portion of the non-fungible token to a further smart wallet associated with a recipient selected by the user.

The method may further include establishing an activation smart contract, wherein the activation smart contract may be deployed on the secret network and may include at least one user selected activation event, wherein upon occurrence of the user selected activation event, the activation smart contract may be configured to cause transfer of the ownership information of the second portion of the non-fungible token to the user selected recipient.

The method may further include periodically monitoring for occurrence of the at least one activation event.

The enabling the user selected recipient to access the data stored in the smart contract upon presentation that the user has possession of the ownership information of the second and third portions of the non-fungible token.

Wherein prior to transfer of the ownership information of the second portion to the user selected recipient, the user may be enabled to view at any time the data stored in the smart contract.

The method may further include enabling a user to make payments for fees associated with creation and deployment of the smart contract, the non-fungible token, and the activation smart contract from any smart wallet.

Certain of the foregoing and related aspects and/or features are readily attained according to the present general inventive concept by also providing a computer-implemented method for automated ownership transfer of digital assets, which includes obtaining a viewing key of a smart contract, encrypting the viewing key, and creating a non-fungible token of the viewing key.

The method may include splitting the non-fungible token into a first portion, a second portion, and a third portion.

The non-fungible token of the viewing key may be configured to be deployable on different or same blockchain networks.

The method may include deploying the first portion to a first blockchain network, deploying the second portion to a second blockchain network, and deploying the third portion to a third blockchain network, wherein the first, second, and third blockchain networks include different or the same blockchain networks.

The method may include receiving user data prior to obtaining the viewing key of the smart contract, encrypting the user data, and storing the user data in the smart contract.

The method may include deploying the smart contract on a secret network subsequent to storing the user data in the smart contract.

The non-fungible token may be split into the first, second, and thirds portions using Shamir's Secret Sharing.

Access to the data in the smart contract may require ownership of at least two of the three non-fungible token portions.

Access to the data in the smart contract may further require identification by at least one biometric security device.

The method may include enabling a user to make payments for fees associated with the creation and deployment of the smart contract and the non-fungible token from any smart wallet.

### BRIEF DESCRIPTIONS OF THE DRAWINGS

These and/or other aspects of the present general inventive concept will become apparent and more readily appreciated from the following description of the embodiments, taken in conjunction with the accompanying drawings of which:

FIG. 1 is a flowchart illustrating a method according to an embodiment of the present general inventive concept;

FIG. 2 is a schematic diagram illustrating a system according to an embodiment of the present general inventive concept;

FIG. 3 is a continuation of the flowchart in FIG. 1 illustrating a method according to an alternative embodiment of the present general inventive concept;

FIG. 4 is a continuation of the flowchart in FIG. 3 illustrating a method according to an alternative embodiment of the present general inventive concept;

FIG. 5 is a continuation of the flowchart in FIG. 4 illustrating a method according to alternative embodiment of the present general inventive concept;

FIG. 6 is a continuation of the flowchart in FIG. 5 illustrating a method according to alternative embodiment of the present general inventive concept;

FIG. 7 is a schematic diagram illustrating exemplary method steps performed by an exemplary system according to the present general inventive concept;

FIG. 8 is a schematic diagram illustrating exemplary method steps performed by an exemplary system according to the present general inventive concept;

FIG. 9 is a schematic diagram illustrating exemplary method steps performed by an exemplary system according to the present general inventive concept;

FIG. 10 is a schematic diagram illustrating exemplary method steps performed by an exemplary system according to the present general inventive concept;

FIG. 11 is a schematic diagram illustrating exemplary method steps performed by an exemplary system according to the present general inventive concept;

FIG. 12 is a schematic diagram illustrating exemplary method steps performed by an exemplary system according to the present general inventive concept;

FIG. 13 is a schematic diagram illustrating exemplary method steps performed by an exemplary system according to the present general inventive concept; and

FIG. 14 is a schematic diagram illustrating a remote electronic device of a user or a recipient according to the present general inventive concept.

### DESCRIPTION OF INVENTION

The exemplary arrangements provide an innovative, revolutionary approach to inheritance and secure storage solutions for the most sensitive information. The aforementioned and other shortcomings of prior attempted solutions are addressed by the exemplary arrangements, which solve the outstanding issues and others by providing an encrypted and fully decentralized solution for passing on assets to an heir in the event of, for example, a personal tragedy or accidental death. The solution provided by the exemplary arrangements empowers users to claim full ownership and autonomy over their digital assets while simultaneously offering an added layer of peace of mind that their keys are, in fact, safe.

Established by the exemplary arrangements or embodiments is a decentralized system in which any user can store sensitive information (e.g., wallet seed and/or secret phrases, centralized exchange credentials, etc.) within a public and secure blockchain and with a variety of configurable recovery mechanisms. The exemplary system can be utilized by an end user to, for example: (1) restore their data in case of loss of access to their sensitive information; and (2) transfer the ownership of this information to specific users, such as heirs, in the case of, for example, an accident or death of the user.

Accordingly, the exemplary arrangements provide an innovative and revolutionary solution, backed by the immutability and security of decentralized blockchain technology, to ensure that all user data is encrypted and protected thoroughly from unauthorized access. To achieve this, the exemplary arrangements utilize one or more of the following tools: (1) a decentralized digital identity service (DID) for user login, (2) Shamir's Secret Sharing (SSS) algorithm, (3) smart contracts and a smart contract vault, and (4) non-fungible tokens (NFTs).

By way of explanation and not as limiting, the following key concepts are to be understood as related to the present invention:

Blockchain is a set of technologies that allow keeping a secure, decentralized, synchronized and distributed record of digital operations, without the need for third-party intermediation.

Decentralized Identity (DID) is a trust framework in which identifiers, such as, for example, usernames, can be replaced with proprietary, independent IDs that enable data exchange using blockchain and distributed ledger technology to protect privacy and secure transactions.

Shamir's Secret Sharing (SSS) [see https://medium.com/@keylesstech/a-beginners-guide-to-shamir-s-secret-sharing-e864efbf3648] is a key distribution algorithm. SSS splits a “secret” into parts called “fragments.” Fragments alone do not reveal any information about the secret, and each fragment is distributed to a group of people for safekeeping. An important feature of SSS is that it is dictated by a threshold, meaning that only two out of three fragments are required to reveal the secret, preventing any failure to decrypt sensitive information in the event of missing or lost fragments. Such an event may occur if the holder of one of three fragments were to die and only the two fragments remained to decrypt the sensitive information.

The vault (also referred to herein as datastore) of the exemplary arrangements (e.g., the “Serenity Shield Vault”) is a custody service offered by a trusted source to store crypto assets.

Non-fungible tokens (NFTs) are cryptographic assets on a blockchain with unique identification codes and metadata that distinguish one from another. NFTs have various use cases.

The content found at all website links set forth herein is hereby incorporated by reference herein.

Reference will now be made in detail to the exemplary arrangements, examples of which are illustrated in the accompanying drawings, wherein like reference numerals refer to the like elements throughout. The exemplary arrangements are described below with reference to the figures.

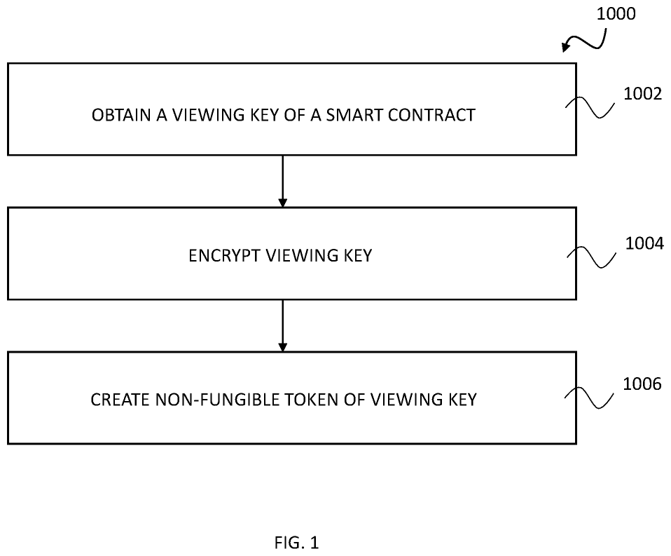

FIG. 1 is a flowchart illustrating an exemplary method 1000 for storing digital assets and transferring ownership thereof under defined the circumstances. The exemplary method comprises the following steps: obtaining a viewing key of a smart contract; encrypting the viewing key of the smart contract; and creating a non-fungible token (“NFT”) of the encrypted viewing key.

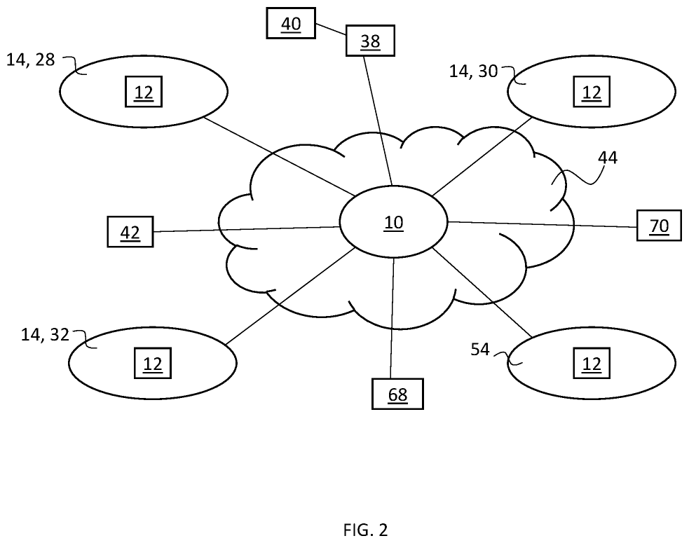

As shown in FIG. 1, the exemplary method 1000 begins at step 1002. Step 1002 comprises the operation of obtaining a viewing key 16 of a smart contract 18. As shown in FIG. 2, the exemplary arrangement includes a system 10. The exemplary system 10 comprises at least one computer or processor that is operative to communicate with nodes of various different blockchain networks. The exemplary system 10 is operative to communicate with a node 12 of a blockchain network 14 to obtain a viewing key 18 of smart contract 16 deployed on the blockchain network 14. However, this method step is merely exemplary, and in other arrangements, other method steps may be used.

In alternative exemplary arrangements, the exemplary system 10 comprises a decentralized application (dApp). In such arrangements, the exemplary system 10 comprises a decentralized digital application that is configured to run or execute on a blockchain network of computers, instead of relying on a single computer. Of course, this arrangement is merely exemplary, and in other embodiments, other arrangements may be used.

In exemplary arrangements, the exemplary system 10 is in operative communication with at least one datastore associated with the system 10. The exemplary datastore includes at least one processor readable medium. The exemplary processor readable medium includes processor executable instructions for executing the numerous functions, operations, routines, and/or subroutines necessary for completion of the method steps discussed herein. When such processor executable instructions are executed by the exemplary processor, the exemplary system 10 is caused to carry out the method steps or portions thereof discussed herein. In alternative exemplary arrangements, the processor executable instruction for completing the method steps discussed herein are held on a blockchain network and are executed by a system 10 comprising a decentralized application (dApp). However, as can be appreciated, these arrangements are merely exemplary, and in other embodiments, other arrangements may be used.

Referring again to FIG. 1, the exemplary method 1000 further comprises step 1004, comprising encrypting the viewing key 16. At step 1004, the exemplary system 10 is configured to cause the viewing key 16 to be encrypted using at least one encryption method. For example, the viewing key 16 may be encrypted using any known encryption method, including but not limited to, data encryption standard (DES), triple data encryption standard (3DES), advanced encryption standard (AES), and/or Rivest-Shamir-Adleman (RSA). As can be appreciated, these method steps and encryption methods are merely exemplary, and in other arrangements, other method steps and encryption methods may be used.

The exemplary method 1000 further comprises step 1006. Step 1006 comprises creating or minting an NFT 20 of the encrypted viewing key 16. That is, at step 1006, the exemplary system 10 is configured to mint an NFT 20 of the viewing key 16. Of course, this method step is merely exemplary, and in other arrangements, other method steps may be taken.

In alternative exemplary arrangements, during step 1006, the exemplary system 10 is configured to mint NFT 20 such that it is configured to be deployable on different blockchain networks. That is, the exemplary NFT 20 is configured to be deployable on multiple different blockchain networks. For example, the exemplary NFT is configured to be deployable on any of the following blockchain networks: Ethereum, Solana, Tezos, Flow, Worldwide Asset Exchange (WAX), and Binance Smart Chain (BSC). However, the blockchain networks to which the NFT 20 is deployable are not limited thereto, and the exemplary NFT 20 may be configured to be deployable to any blockchain network configured to support and/or manage non-fungible tokens. Of course, this arrangement is exemplary, and in other embodiments, other arrangements may be used.

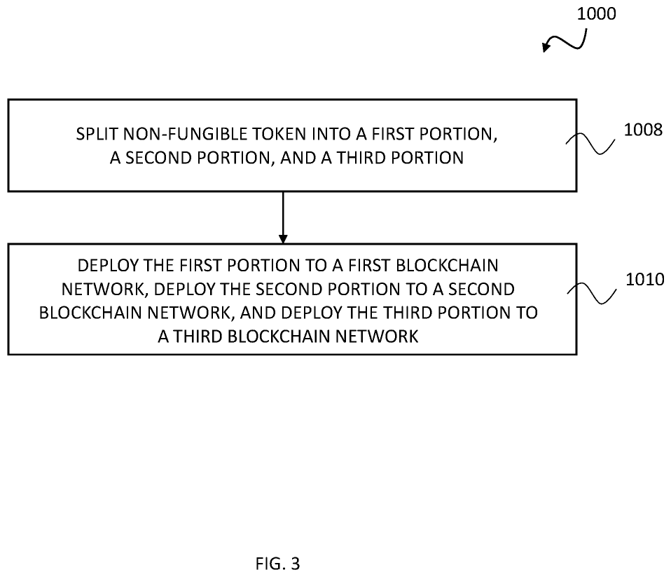

Now referring to FIG. 3, which illustrates and alternative exemplary method according to exemplary arrangements. In an alternative exemplary arrangement, the exemplary method 1000 further includes step 1008. At step 1008, the exemplary system 10 is configured to cause the NFT 20 of the viewing key 16 to be split into a first portion 22, a second portion 24, and a third portion 26. Each of the first portion 22, the second portion 24, and the third portion 26 include their own private key in association therewith. That is, each portion of the split NFT 20 includes its own private key such that it can be transferred to addresses or public keys of blockchain smart wallets, as will be discussed in greater detail later. However, this method step is merely exemplary, and in other arrangements, other method steps may be used.

In exemplary arrangements, during step 1008, the exemplary system 10 is configured to cause the NFT 20 of the viewing key 16 to be split into the first portion 22, the second portion 24, and the third portion 26 through use of Shamir's Secret Sharing (“SSS”). In such arrangements, in order to access the viewing key within the NFT 20, a minimum number of portions of the NFT must be presented to the system 10 in order to access, obtain, or view the viewing key 16 within the NFT 20. For example, an individual attempting to obtain the viewing key, to thereby access, obtain, or view the contents of the smart contract 18, must present to the system 10 that the user is in possession of the ownership information of at least two portions of the NFT 20. As used herein, the term “ownership information” means all data, information, private and/or public keys, or any other information used to identify and confirm ownership of a non-fungible token.

In alternative exemplary arrangements, the exemplary system 10 is operative to split the NFT 20 of the viewing key 16 into multiple parts, shares, or portions via other secret sharing schemes including, but not limited to, Blakley's Secret Sharing, Mignotte's Scheme, or Asmuth-Bloom's Scheme. However, these secret sharing schemes are merely exemplary, and in other arrangements, other secret sharing schemes may be used. Still referring to FIG. 3, in alternative exemplary arrangements, exemplary method 1000 further includes step 1010. At step 1010, the exemplary system 10 is operative to deploy the first portion 22 of the NFT 20 to a first blockchain network 28, to deploy the second portion 24 of the NFT 20 to a second blockchain network 30, and to deploy the third portion 26 to a third blockchain network 32. The exemplary first, second, and third blockchain networks may all comprise same or different blockchain networks. For example, the blockchain networks 28, 30, and 32 may comprise Ethereum (ERC-20), Ethereum (ERC-721), Solana, or Binance Smart Chain (BSC). However, blockchain networks 28, 30, and 32 are not limited hereto and may comprise any blockchain network configured to support and/or manage non-fungible tokens. As can be appreciated, this method step is merely exemplary, and in other arrangements, other method steps may be used.

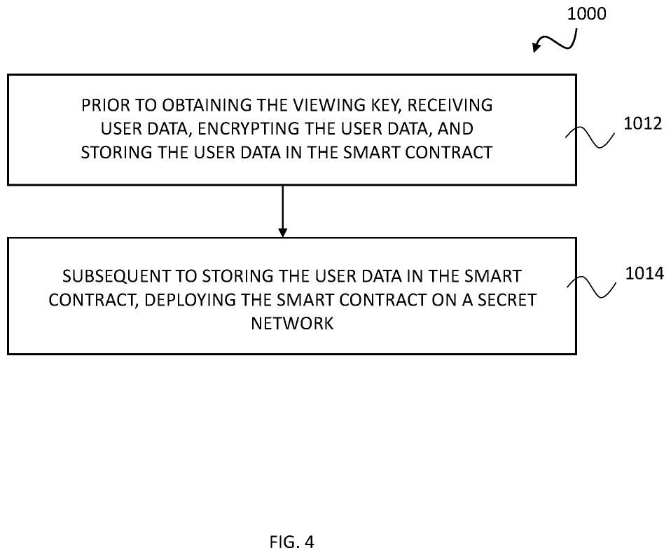

Referring now to FIG. 4, which illustrates and alternative exemplary method according to exemplary arrangements. In alternative exemplary arrangements, the exemplary method 1000 further includes step 1012. The exemplary step 1012 takes place prior to 1002. That is, in exemplary arrangements, step 1012 is executed by the system 10 prior to obtaining viewing key 16 of smart contract 18. At step 1012, the exemplary system 10 is configured to receive user data 34 from a user 36, encrypt the user data 34, and to store the user data in the smart contract 18 (i.e., the smart contract from which the viewing key is obtained).

That is, at step 1012, through connection to the system 10, a user 36 is enabled to upload user data 34 to the system 10. The exemplary system 10 is configured to encrypt the user data 34 through any of the encryption methods discussed herein. The exemplary system 10 is configured to then cause the user data to be stored in a smart contract 18. In further alternative exemplary arrangements, the exemplary system 10 connects to other external systems or software to complete the operations of step 1012. However, this method step is merely exemplary, and in other arrangements, other method steps may be used.

In such exemplary arrangements, the exemplary system 10 includes system software 38. The exemplary system software 38 is enabled to be downloaded to a user's remote electronic device or to be accessed through an internet-based web application. The exemplary software 38 includes processor executable instructions that when executed by a processor of a remote electronic device execute the operations and functions of the method steps discussed herein, in conjunction with the operations and functions of system 10. The exemplary system software 38 includes a user interface 40 that is configured to enable the user 36 to interact with the system 10 and to provide inputs to and outputs from the system 10 in order to facilitate execution of the steps of exemplary method 1000.

For example, the exemplary user 36 may download the system software 10 to a remote electronic device 42 owned by or associated with the user 36. The exemplary remote electronic device 42 may comprise, for example, a smart phone, a laptop computer, a desktop computer, a smart tablet or pad, or any other smart device. The exemplary remote electronic device 42 is configured to communicate with the system 10 via at least one telecommunications network 44. The exemplary remote electronic device 42 includes an input device 46 such as mouse, a touch screen or microphone, an output device 48 such as a monitor, a display screen or audio output device, a processor 50, and at least one memory 52. As can be appreciated, the exemplary remote electronic device 44 further includes a battery, circuitry, and any other components necessary to cause the operations and functions discussed herein that are executed in conjunction with the system 10. Of course, these arrangements the remote electronic device are merely exemplary, and in other embodiments, other arrangements may be used.

Still referring to FIG. 4, in alternative exemplary arrangements, the exemplary method 1000 further comprises step 1014. At 1014, subsequent to storing the user data 34 in the smart contract 18, the smart contract 18 is deployed on a secret network 54. That is, exemplary system 10 is configured to deploy the smart contract 18 including the encrypted user data 34 to a secret network 54. The exemplary secret network 54 comprises a blockchain network that is configured to manage privacy preserving smart contracts. That is, the exemplary secret blockchain network is configured to support encrypted inputs, encrypted outputs, and encrypted states for smart contracts, thereby providing data privacy for sensitive information stored on a blockchain. The exemplary secret network 54 is configured such that the contents and/or configuration of the smart contract 18 deployed thereon cannot be viewed to the public. This is in contrast to non-secret blockchain networks in which the public is enabled to view the contents and/or configuration of the smart contract deployed on the non-secret blockchain network. In further alternative exemplary arrangements, the exemplary system 10 connects to other external systems or software to complete the operations of step 1014. As can be appreciated, this method step is merely exemplary, and in other embodiments, other method steps may be used.

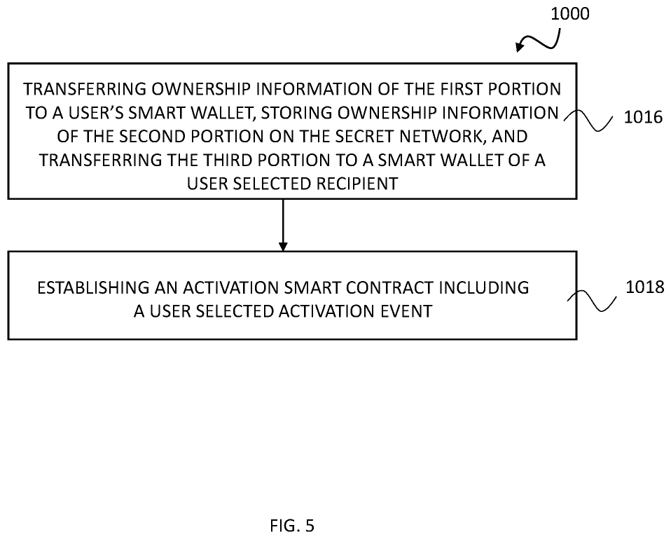

Now referring to FIG. 5, which illustrates an alternative exemplary method according to exemplary arrangements. In exemplary arrangements, the exemplary method 1000 further includes step 1016. At step 1016, the exemplary system 10 is configured to transfer ownership information of the first portion 22 of the NFT 20 to a smart wallet associated with a user 36, to store ownership information of the second portion 24 of the NFT 20 in a datastore 56 (held on the secret network 54) in operative communication with the system 10, and to transfer ownership information of the third portion 26 of the NFT 20 to a smart wallet associated with a user selected recipient 58. As previously discussed, as used herein, the term “ownership information” means all data, information, private and/or public keys, or any other information used to identify and confirm ownership of a non-fungible token. However, this method is merely exemplary, and in other arrangements, other method steps may be used.

In step 1016, the exemplary system 10 is configured to cause the ownership information of the first portion 22 of the NFT 20 to be transferred to a smart wallet 60 associated with the user 36. In exemplary arrangements, the exemplary user 36 already has a smart wallet 60 which the user 36 utilizes to store his or her first portion 22 of the NFT 20. The exemplary system 10 is configured to communicate with the software system on which the user's smart wallet 60 is established. That is, the exemplary system 10 is configured to communicate with other systems or software that manage the user's smart wallet 60. The exemplary system 10 is operative to cause the ownership information associated with the first portion 22 of the NFT 20 to be transferred to the user's smart wallet 60.

In alternative exemplary arrangements, the exemplary smart wallet 60 is configured to be compatible with the secret network 54. That is, the exemplary wallet 60 is configured to enable the user 36 to pay fees, such as “gas fees”, to the secret network 54 for use of the secret network 54. For example, the exemplary smart wallet 60 is a Torus or Keplr smart wallet, thereby enabling the “gas fees” to be paid for use of the secret network 54. However, in still other alternative exemplary arrangements, the exemplary smart wallet 60 is configured to pay all fees to the system 10, and the exemplary system 10 is configured to pay a portion of those fees to an account associated with the secret network 54 for use thereof. Of course, these arrangements and method steps are merely exemplary, and in other embodiments, other arrangements and method steps may be used.

At step 1016, the exemplary system 10 is configured to transfer the ownership information of the second portion 24 of the NFT 20 to the datastore 56 in operative communication with the system 10. In exemplary arrangements, the exemplary data store 56 comprises a data store that is configured to be held on a blockchain network, in particular, held on the secret network 54. The exemplary system 10 and the datastore 56 are enabled to send and receive data and information from one another via a secure telecommunication network. In alternative exemplary arrangements, the datastore 56 may comprise a traditional data store not held on a blockchain network, including one or more of several types of mediums suitable for storing in a secure manner the ownership information associated with the second portion 24 of the NFT 20. The exemplary datastore 56 is sufficient to store ownership information of a plurality of NFT portions that are associated with a plurality of users. The exemplary system 10 is configured to access or receive the ownership information associated with a specific portion of an NFT. For example, on command, the exemplary system 10 is configured to access the ownership information of the second portion 24 of the NFT 20 that is stored in the datastore 56.

In alternative exemplary arrangements, the exemplary second portion 24 of the NFT 20 is stored on the secret network 54. That is, the exemplary system 10 is configured to cause the second portion 24 of the NFT 20 to be held on a secret blockchain network. In such arrangements, as discussed, the exemplary system 10 is configured to establish a data repository, smart contract, or “file vault” that is held on the secret blockchain network 54. The exemplary repository, smart contract, or “file vault” is configured to store respective ownership information of a plurality of portions of NFTs of a plurality of users. Additionally, the exemplary system 10 is configured to access or receive the ownership information of a portion of an NFT on demand. As can be appreciated, these configurations and methods steps are merely exemplary, and in other embodiments, other configurations and method steps and configurations may be used.

At step 1016, similar to causing the ownership information of the first portion 22 of the NFT 20 to be transferred to the smart wallet 60 of the user 36, the exemplary system 10 is configured to cause the ownership information of the third portion 26 of the NFT 20 to be transferred to a smart wallet 62 associated with the user selected recipient 58. The exemplary wallet 62 may be identical in its configuration as to wallet 60, such that fees may be paid to the secret network for use thereof. However, the exemplary wallet 62 may comprise any type of smart wallet.

In exemplary arrangements, the user selected recipient 58 already has a smart wallet 62 that is utilized to store the ownership information of his or her third portion 26 of the NFT 20. Similar to wallet 60, the exemplary system 10 is configured to communicate with the software or system on which the smart wallet 62 is established. That is, the exemplary system 10 is configured to communicate with the system or software that manages the user selected recipient's 58 smart wallet 62, i.e., the exemplary wallet 62 is compatible with the system 10 and is compatible with the secret network 54.

In alternative exemplary arrangements, if the user 36 and the user selected recipient 58 do not already have an established smart wallet, the exemplary system 10 is configured to enable the user 36 and the user selected recipient 58 to establish a smart wallet. That is, the exemplary system 10 prompts the user 36 and the user selected recipient 58 to establish a smart wallet through notifications or messages received via the user interface 40 of the system software 38 to remote electronic device 42 associated with the user 36 or recipient 58. The exemplary smart wallets created by the system 10 are configured to be compatible with the system 10 and the secret network 54. Of course, these methods of transferring ownership information of the portions of the NFT 20 are merely exemplary, and in other arrangements, other methods may be used.

Still referring to FIG. 5, in alternative exemplary arrangements, the exemplary method 1000 further includes step 1018. At step 1018, the exemplary system 10 is configured to establish an activation smart contract 64. The exemplary system 10 is configured to deploy the activation smart contract 64 on the secret network 54. The exemplary activation smart contract 64 includes at least one user selected activation event 66. The exemplary system 10 is configured to monitor for occurrence of the user selected activation event 66. Upon occurrence of the user selected activation event 66, the exemplary system 10 is configured to cause the ownership information of the second portion 24 of the NFT 20 that is held by system 10 on the secret network 54 to be transferred to the smart wallet 62 of the user selected recipient 58. As can be appreciated, these configuration and method steps are merely exemplary, and in other embodiments, other configurations and method steps may be used.

In exemplary arrangements, the user selected activation event 66 comprises an event, time, or situation that the user 36 selects through the user interface 40 of system software 38. Upon occurrence of the user selected activation event 66, the system 10 is configured to cause transfer of the ownership information of the second portion 24 of the NFT 20 to the smart wallet 62 of the user selected recipient 58. For example, the user 36 may select his or her own death as the activation event 66. In this way, upon the death of the user 36, the system 10 is operative to transfer the ownership information of the second portion 24 of the NFT 20 to the smart wallet 62 of the user selected recipient 58. However, these configurations and method steps are merely exemplary, and in other arrangements, other configurations and method steps may be used.

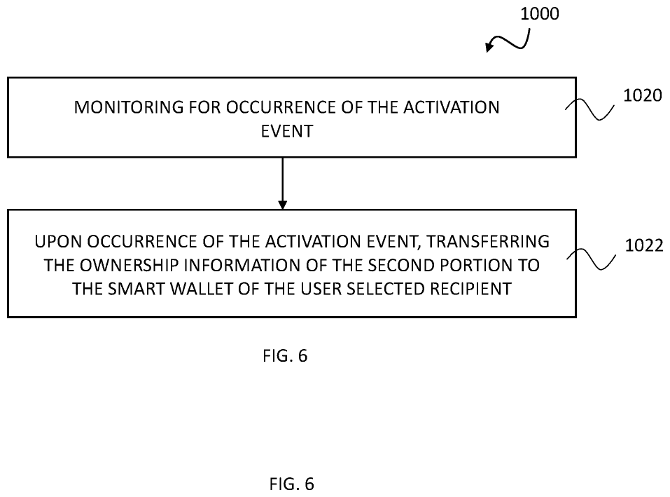

Now referring to FIG. 6, which illustrates an alternative exemplary method according to exemplary arrangements. The exemplary method 1000 further includes step 1020. At step 1020, the exemplary system 10 is configured to monitor for occurrence of the user selected activation event 66. The exemplary system 10 is configured to monitor for activity of the user 36 on the system software 38 and transactions by the user 36 on blockchain networks. In other arrangements, the exemplary system 10 is configured to monitor for occurrence of the activation event 66 by sending status update messages or making automated phone calls to the user 36 to prompt a response from the user 36 that the user's 36 death has not occurred. If after monitoring, the system 10 determines that the activation event 66 has occurred, the system 10 is configured to initiate transfer of the second portion of NFT 20.

In alternative exemplary arrangements, the system 10 includes a mandatory procedure that the system 10 must complete before transferring the ownership information of the second portion to the wallet 62 of the user selected recipient. For example, the system 10 may monitor for user 36 activity on the system software 38 and the for user 36 activity on blockchain networks, then the system 10 may attempt to contact the user 36 a set number of times, then the system 10 may attempt to contact the user selected recipient 58 a number of times, and/or the other individuals whom the user 36 may have indicated as contacts through the interface 40 of the system software 38. However, these monitoring methods are merely exemplary, and in other arrangements, other monitoring methods and procedures may be used.

The exemplary user selected activation event 66 may comprise other events, times, or situations. For example, the exemplary activation event 66 may comprise an event, time, or other situation conditioned on the user selected recipient 58. The activation event 66 may comprise the user selected recipient 58 becoming a certain age, graduating from an educational institution, achieving a certain goal, or any other event. The exemplary system 10 is configured to monitor for occurrence of these alternative user selected activation events 66 through any of the monitoring methods discussed above. For example, the exemplary system 10 may monitor for occurrence by sending messages through the user interface 40 or making phone calls to the user 36 and the user selected recipient 58 and prompting a response from the user 36 and/or the recipient 58 indicating that the user selected activation event 66 has occurred. In alternative exemplary arrangements, the system 10 may check with oracles or external public systems to verify that the activation event 66 has occurred. However, as can be appreciated, these methods steps are merely exemplary, and in other arrangements, other method steps may be used.

Still referring to FIG. 6, the exemplary method 1000 further includes step 1022. At step 1022, after determining that the activation event 66 has occurred, the exemplary system 10 is configured to transfer the ownership information of the second portion 24 of NFT 20 to the smart wallet 62 of the recipient. However, this arrangement is merely exemplary, and other methods steps may be used.

As previously discussed, access to the contents or user data 34 stored in the smart contract 18 requires presentation or showing possession to the system 10 of the ownership information of at least two portions of the NFT 20. That is, the user selected recipient 58 must prove ownership of at least two portions of the NFT 20. For example, after the recipient 58 has requested access to the contents of the smart contract 18, the system 10 is configured to verify that the smart wallet 62 of the user selected recipient 58 includes the ownership information of two portions of the NFT. For example, the system 10 will verify that the smart wallet 62 of the recipient 58 includes the private key for the second portion 24 of the NFT 20 and the private key of the third portion 26 of the NFT 20. However, these configurations and method steps are merely exemplary, and in other arrangements, other configurations and method steps may be used.

As such, upon the system 10 transferring the ownership information of the second portion 24 of the NFT 20 to the recipient 58 after occurrence of the user selected activation event 66, the recipient 58 is enabled to access and/or claim possession of the contents or user data 34 stored in the smart contract 18.

For example, the contents or user data 34 of the smart contract 18 may comprise ownership information for digital assets having a monetary value. Upon the system 10 verifying that the smart wallet 62 of the recipient 58 includes the ownership information of two portions of the NFT 20 (i.e., the second 24 and third 26 portions), the system 10 is configured to enable the recipient 58 to access, obtain, or claim possession of the contents or user data 34 stored within the smart contract 18. Of course, this arrangement is merely exemplary and is not limited hereto.

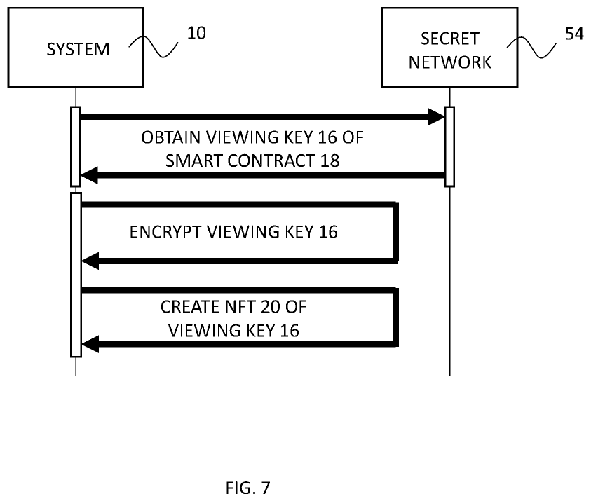

Now referring to FIGS. 7-13, which illustrate exemplary method steps performed by the exemplary system 10.

As shown in FIG. 7, the exemplary system 10 is configured to obtain viewing key 16 of smart contract 18 from the secret network 54. The exemplary system 10 is configured to encrypt the viewing key 16. The exemplary system 10 is configured to create NFT 20 of the viewing key 16.

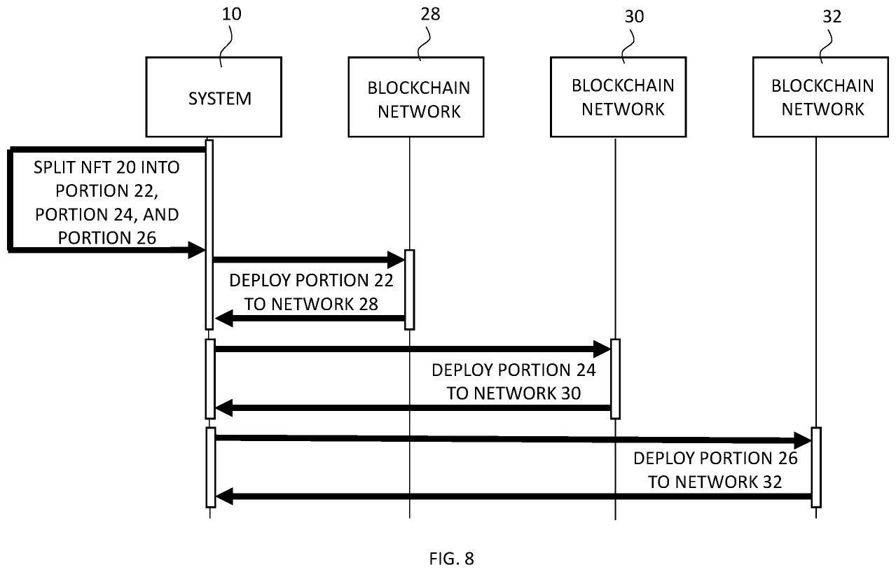

As shown in FIG. 8, the exemplary system 10 is configured to split NFT 20 into portion 22, portion 24, and portion 26. The exemplary system 10 is then configured to deploy portion 22 to blockchain network 28, deploy portion 24 to blockchain network 30, and deploy portion 26 to blockchain network 32.

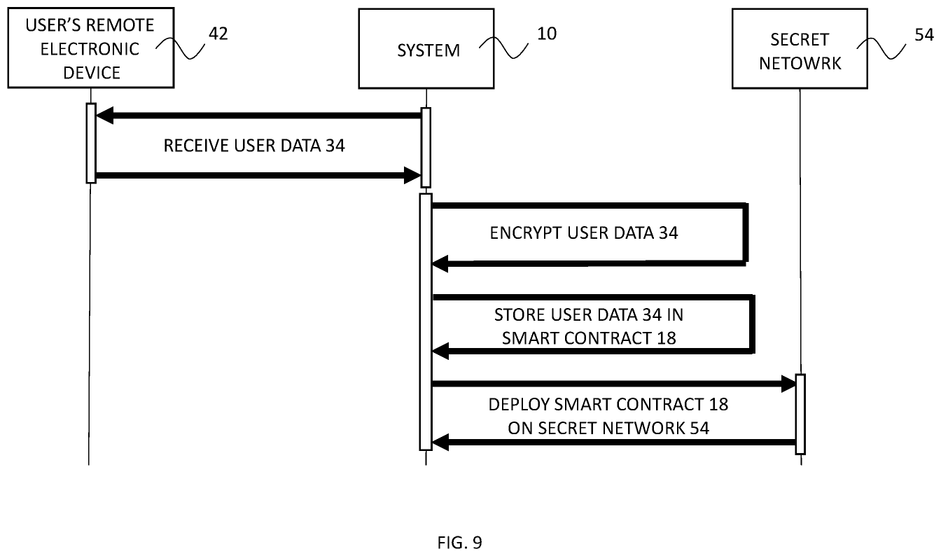

As shown in FIG. 9, the exemplary system 10 is configured to receive user data 34 from the remote electronic device 42 associated with the user 36. The exemplary system 10 is configured to then encrypt the user data 34. The exemplary system 10 is configured to then store the user data 34 in smart contract 18. The exemplary system 10 is configured to deploy smart contract 18 to the secret network 54.

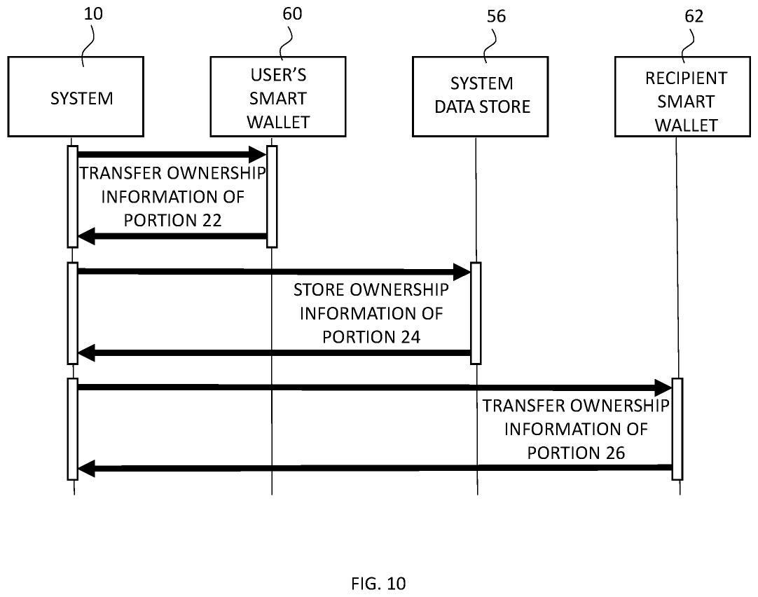

As shown in FIG. 10, The exemplary system is configured to transfer the ownership information of portion 22 to the smart wallet 60 associated with the user 36. The exemplary system 10 is configured to store the ownership information of portion 24 in the system data store 56 or on the secret network 54. The exemplary system 10 is configured to transfer the ownership information of portion 26 to the smart wallet 62 associated with the recipient 58.

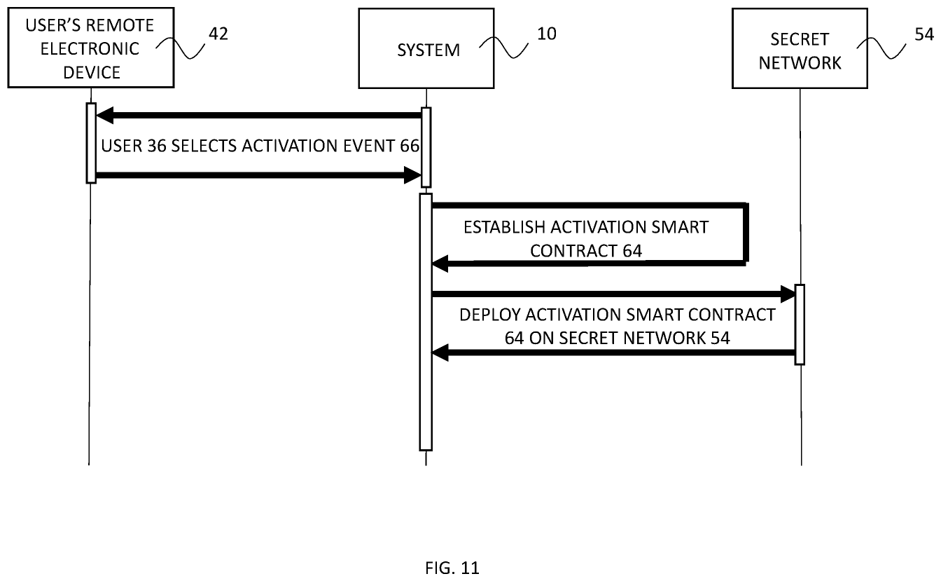

As shown in FIG. 11, the system 10 is configured to receive a user selected activation event 66 from the remote electronic device 42 associated with the user 36. The exemplary system 10 is configured to establish the activation smart contract 64. The exemplary system 10 is configured to deploy the activation smart contract 64 on the secret network 54.

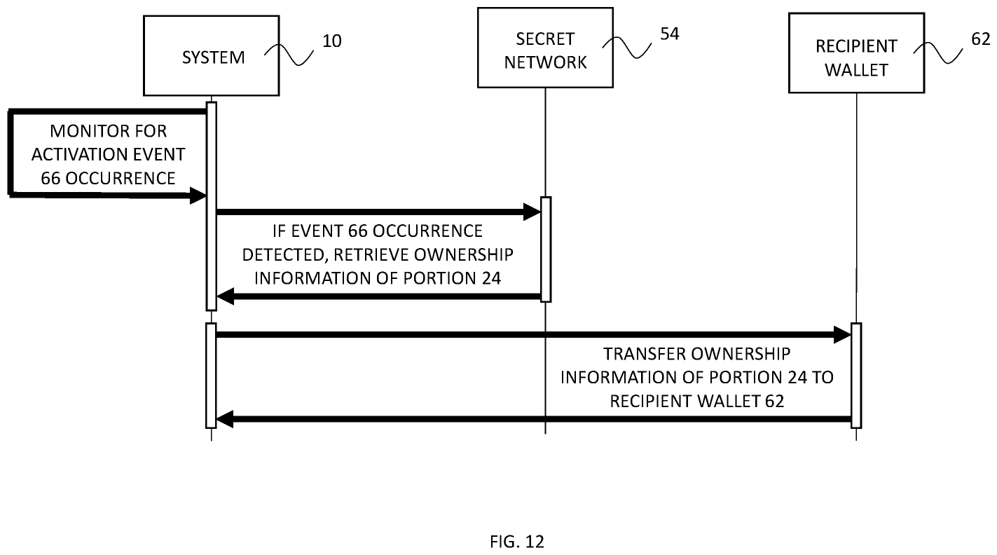

As shown in FIG. 12, The exemplary system 10 is configured to monitor for occurrence of the activation event 66. If occurrence of the activation event 66 is detected, the exemplary system 10 is configured to retrieve the ownership information of portion 24 of NFT 20 from the data store 56 and/or the secret network 54. The exemplary system 10 is configured to transfer the ownership information of portion 24 to the smart wallet 62 associated with the recipient 58.

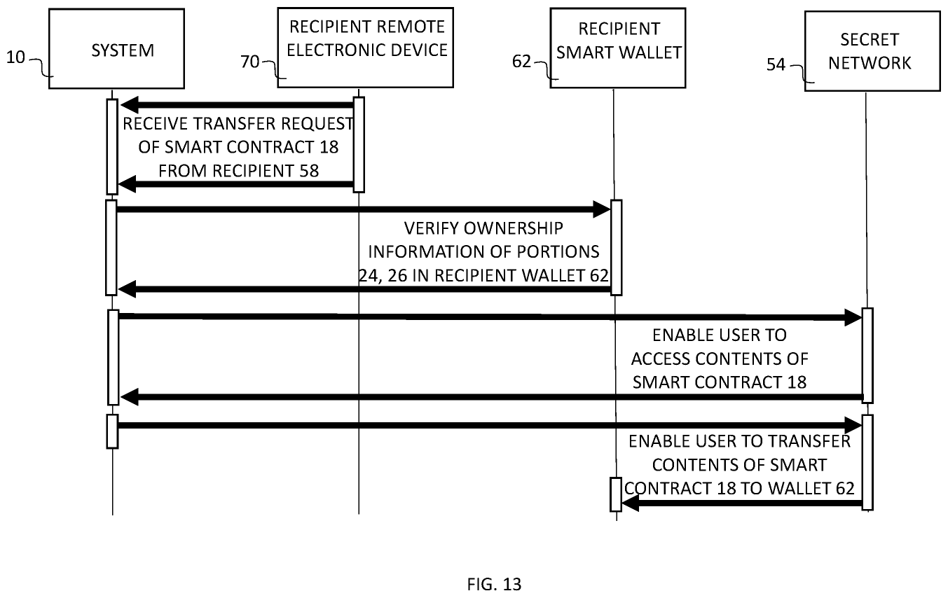

As shown in FIG. 13, the exemplary system 10 is configured to receive a transfer request from the remote electronic device 70 associated with the recipient 58. The exemplary system 10 is configured to verify the ownership information of portions 24 and 26 in the smart wallet 62 associated with the recipient 58. The exemplary system 10 is configured to then enable the user 36 to access the contents of the smart contract 18, and/or to enable the user 36 to transfer the contents of the smart contract 18 to the smart wallet 62 associated with the recipient 58.

Of course, as can be appreciated, these methods steps are merely exemplary, and in other arrangements, other method steps may be used.

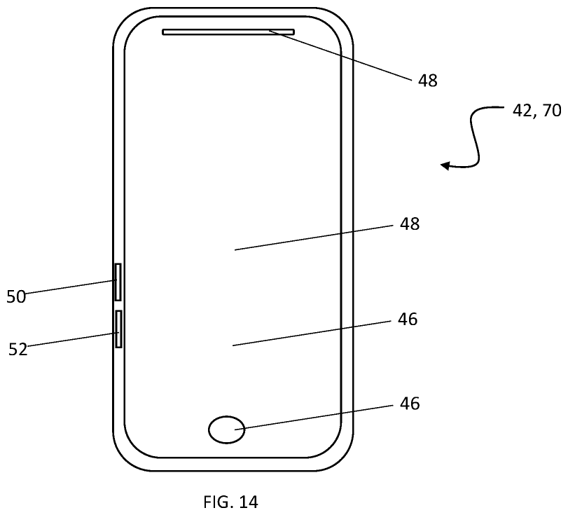

Now referring to FIG. 14, which illustrates a remote electronic device 42 associated with the user 36 and a remote electronic device 70 associated with the recipient 58. However, this arrangement of the remote electronic device is merely exemplary, and other arrangements may be used.

In alternative exemplary arrangements, prior to transfer of the second portion 24 of the NFT 20 to the user selected recipient 58, the user 36 is enabled to view at any time the contents of the smart contract 18. That is, the exemplary system 10 enables the user 36 to use the second portion 24 of the NFT 20 held by the system 10 on the secret network 54 along with the first portion 22 of the NFT that is included in the user's 36 smart wallet 60 to access, obtain, or claim possession of the contents of the smart contract 18.

In alternative exemplary arrangements, prior to transfer of the second portion 24 of the NFT 20 to the user selected recipient 58, the exemplary user 36 is enabled to change the contents of the smart contract 18. In this way, the exemplary user 36 enabled to maintain control over the user data 34 and/or other contents stored in the smart contract 18. For example, if the user 36 changes his or her mind about what user data, contents, or digital assets the user 36 wants to be transferred to the recipient 58 upon occurrence of the activation event 66, the exemplary user 36 is enabled to make such change. For example, the user 36 may elect to revoke, add to, or otherwise modify the user data, contents, or digital assets stored in the smart contract 18.

In alternative exemplary arrangements, the system 10 is configured to enable the user 36 to create a smart wallet 62 for the user selected recipient 58. In this way, the exemplary system 10 enables the user 36 to establish a future transfer of user data 34 or other contents stored in a smart contract 18 without the intended recipient ever knowing. For example, the user 36 is enabled to create a future transfer for heirs that are not yet born, heirs that are too young or not competent to establish their own smart wallet 62, or for heirs which the user 36 does not want to know the user 36 has established a future asset transfer. [0082] In alternative exemplary arrangements, the system 10 is configured to be compatible with any smart wallet. That is, the exemplary user 36 is enabled to connect or link any smart wallet configuration to the system 10. In still other alternative exemplary arrangements, the system 10 may enable the user to create a smart wallet of any configuration through use of the user interface 40. For example, smart wallet configurations may include, but are not limited to, Metamask, Phantom, Binance Wallet, etc.

In alternative exemplary arrangements, the system 10 is configured to receive payments from the user 36 and the recipient 58. The exemplary system 10 is configured to receive these payments via the smart wallets associated with the user 36 and the recipient 58. In exemplary arrangements, the system 10 is configured to receive these payments into a reception wallet 68. The exemplary reception wallet 68 comprises a smart wallet of any configuration. The exemplary reception wallet 68 is configured to receive payments of any form of fiat currency, crypto currency, or other currency from the smart wallets associated with the user 36 and the recipient 58. For example, the reception wallet 68 is configured to receive payments from the user 36 for use of the system 10 and/or for use of the secret network 54.

In alternative exemplary arrangements, the system is 10 is configured to enable payments to be made in any form of fiat currency, crypto currency, or other currency via a swap wallet 70 managed by the system 10. The exemplary swap wallet 70 enables a user 36 or a recipient 58 to exchange one currency for another. In particular, the exemplary swap wallet 70 enables the exchange of one crypto currency for another. In alternative exemplary arrangements, the system 10 enables external swap wallet systems or software to link with the system 10 in order to accomplish the currency exchange. For example, external swap wallets may be utilized via application programming interfacing.

In alternative exemplary arrangements, before a user may begin to interact with the system 10 via the user interface 40 of the system software 38, the system 10 is configured to require user authorization. In exemplary arrangements, the user authorization may comprise at least one of passwordless flow authentication, social media single-sign-on authentication, or authentication by at least one biometric security device. The exemplary biometric security device comprises, but is not limited to, fingerprint scanning, facial recognition, iris scan, voice recognition, hand geometry, and retina control.

Although a few exemplary arrangements and methods have been illustrated and described, it will be appreciated by those skilled in the art that changes may be made in these exemplary arrangements and methods, and further combinations of the features and relationships and method steps may be made, without departing from principles and spirit of the disclosure, the scope of which is defined in the appended claims and their equivalents.

1. A computer implemented method, the method comprising:
obtaining a viewing key of a smart contract;
encrypting the viewing key; and
creating a non-fungible token of the viewing key.

2. The computer implemented method according to claim 1, further comprising:
splitting the non-fungible token into a first portion, a second portion, and a third portion.

3. The computer implemented method according to claim 2, wherein the non-fungible token of the viewing key is configured to be deployable on different or same blockchain networks.

4. The computer implemented method according to claim 3, further comprising:
deploying the first portion to a first blockchain network, deploying the second portion to a second blockchain network, and deploying the third portion to a third blockchain network,
wherein the first, second, and third blockchain networks comprise different or same blockchain networks.

5. The computer implemented method according to claim 4, further comprising:
prior to obtaining the viewing key of the smart contract,
receiving user data, encrypting the user data, and
storing the user data in the smart contract.

6. The computer implemented method according to claim 5, subsequent to storing the user data in the smart contract, deploying the smart contract on a secret network.

7. The computer implemented method according to claim 6, wherein the non-fungible token is split into the first, second, and thirds portions using Shamir's Secret Sharing.

8. The computer implemented method according to claim 7, wherein access to the data in the smart contract requires ownership of at least two of the three non-fungible token portions.

9. The computer implemented method according to claim 8, wherein access to the data in the smart contract further requires identification by at least one biometric security device.

10. The computer implemented method according to claim 9, further comprising:
enabling a user to make payments for fees associated with creation and deployment of the smart contract and the non-fungible token from any smart wallet.

11. A computer implemented method, the method comprising:
encrypting user data;
creating a smart contract, wherein the smart contract includes the encrypted user data, is deployed on a secret network, includes a viewing key, wherein the viewing key controls access to the data of the smart contract, and is configured to mint non-fungible tokens;
obtaining the viewing key of the smart contract, encrypting the viewing key, minting via the smart contract a non-fungible token of the encrypted viewing key, splitting the non-fungible token into a first portion, a second portion, and a third portion, wherein each portion includes at least a part of the viewing key.

12. The computer implemented method of claim 11, wherein the non-fungible token is configured to be deployable on different blockchain networks.

13. The computer implemented method of claim 12, further comprising:
deploying each of the first portion, second portion, and third portion of the non-fungible token to a different blockchain network.

14. The computer implemented method of claim 13, wherein access to the data in the smart contract requires ownership of at least two portions of the non-fungible token.

15. The computer implemented method of claim 14, further comprising:
transferring ownership information of the first portion of the non-fungible token to a smart wallet associated with a user, storing ownership information of the second portion of the non-fungible, and
transferring ownership information of the third portion of the non-fungible token to a further smart wallet associated with a recipient selected by the user.

16. The computer implemented method of claim 15, further comprising: establishing an activation smart contract, wherein the activation smart contract is deployed on the secret network and includes at least one user selected activation event, wherein upon occurrence of the user selected activation event, the activation smart contract is configured to cause transfer of the ownership information of the second portion of the non-fungible token to the user selected recipient.

17. The computer implemented method of claim 16, further comprising: periodically monitoring for occurrence of the at least one activation event.

18. The computer implemented method of claim 17, enabling the user selected recipient to access the data stored in the smart contract upon presentation that the user has possession of the ownership information of the second and third portions of the non-fungible token.

19. The computer implemented method of claim 18, wherein prior to transfer of the ownership information of the second portion to the user selected recipient, the user is enabled to view at any time the data stored in the smart contract.

20. The computer implemented method according to claim 19, further comprising: enabling a user to make payments for fees associated with creation and deployment of the smart contract, the non-fungible token, and the activation smart contract from any smart wallet.
